(19) United States
(12) Patent Application Publication
(10) Pub. No.: US 2023/0072376 A1
(43) Pub. Date: Mar. 9, 2023

(54) TRANSMISSION OF PACKETS AT SPECIFIC TRANSMIT TIMES WITH PREEMPTION

(71) Applicant: Marvell Israel (M.I.S.L) Ltd., Yokneam (IL)

(72) Inventors: Yaron Kittner, Pardes Hanna-Karkur (IL); Joergen P.R. Hofman-Bang, Ballerup (DK); Rami ZEMACH, Givat Shapira (IL); Nitzan DROR, Ramot Hashavim (IL)

(21) Appl. No.: 17/900,773

(22) Filed: Aug. 31, 2022

Related U.S. Application Data
(60) Provisional application No. 63/239,289, filed on Aug. 31, 2021.

(51) Int. Cl. H04L 47/62

(52) U.S. Cl. CPC H04L 47/62

(57) ABSTRACT

A network device includes a first queue for queueing express packets and a second queue for queueing preemptable packets that are to be transmitted via a network interface of the network device. The network device also includes a transmit controller that receives a packet directed to the first queue and determines whether the packet is a type of packet that requires transmission at a specific transmit time from the network interface of the network device. In response to determining that the packet is a type of packet that requires transmission at a specific transmit time, the transmit controller suspends an ongoing transmission of a preemptable packet from the second queue that would prevent transmission of the packet from the first queue at the specific transmit time via the network interface and causes the packet in the first queue to be transmitted at the specific transmit time via the network interface.

### CROSS REFERENCES TO RELATED APPLICATIONS

This application claims the benefit of U.S. Provisional Patent Application No. 63/239,289, entitled “Forward Time-Stamping with Preemption,” filed on Aug. 31, 2021, which is incorporated herein by reference in its entirety.

### FIELD OF TECHNOLOGY

The present disclosure relates generally to communication networks, and more particularly to devices and techniques for transmitting packets at specific transmit times from a network device.

### BACKGROUND

A network device, such as a network switch, a router, an endpoint device, etc. sometimes transmits packets that require transmission at specific transmit times from a network interface of the network device. For example, the network device sometimes transmits timestamped packets, such as timing packets used for clock synchronization; in some cases, the network device inserts a forward timestamp into a packet, the forward timestamp corresponding to a future time relative to the time of insertion of the timestamp into the packet. This is done, for example, because further processing (e.g., encryption, etc.) needs to be performed on the packet after timestamping of the packet and before transmission of the packet from the network device, and thus a forward timestamp is embedded into the packet to accurately reflect the specific transmit time at which the packet is actually transmitted from the network device.

In order to ensure that transmission of a packet from a network interface via a network interface can occur at a specific transmit time, the network device typically waits until the network interface is clear to dispatch the packet for transmission via the network interface so that transmission of the packet is not blocked by transmission of any other packet via the network interface at the specific transmit time. Further, to ensure that a packet dispatched for transmission via the network interface is not prematurely transmitted from the network interface in case the packet is a type of packet that requires transmission at a specific transmit time is dispatched for transmission via the network interface, the network device typically proactively suspends transmission of packets via the network interface prior to determining whether the packet is a type of packet that requires transmission at a specific transmit time. Then, if the network device determines that the packet is a type of packet that requires transmission at a specific transmit time, the network device continues holding transmission via the network interface until the specific transmit time. Otherwise, if the network device determines that the packet is not a type of packet that requires transmission at a specific transmit time, the network device releases transmission from the network interface.

Some network devices implement preemption mechanisms to allow certain time critical or scheduled transmission packets, sometimes referred to as express packets, to be transmitted ahead of other packets, sometimes referred to as preemptable packets. Such network devices utilize an express channel for transmission of express packets via a network interface and a separate preemptable channel for transmission of preemptable packets via the network interface. Generally, when an express packet is ready to be transmitted via the express channel, ongoing transmission of a preemptable packet via the preemptable channel is temporarily suspended for transmission of the express packet via the express channel and is later resumed after transmission of the express packet.

In a network device that utilizes both an express channel and a preemptable channel for transmission of packets via a network interface, it is challenging to ensure that transmission of a packet at a specific transmit time via the network interface is not blocked by transmission of any other packet at the specific transmit time via the network interface at the specific transmit time, either i) without significantly delaying the specific transmit time at which the packet can be transmitted by waiting until both the express channel and the preemptable channel are clear before dispatching the packet for transmission via the network interface or ii) if express channel is used for transmission of the packet, without reducing wire speed of transmission via the preemptable channel by proactively suspending transmission from the preemptable channel each time the express channel is clear, particularly if transmission from the preemptable channel is suspended before determining that a packet dispatched for transmission via the express channel is a type of packet that requires transmission at a specific transmit time.

### SUMMARY

In an embodiment, a network device comprises: a first queue configured to queue express packets to be transmitted via a network interface of the network device, the express packets including one or more types of packets that require transmission at specific transmit times; a second queue configured to queue preemptable packets that are to be transmitted via the network interface of the network device, the preemptable packets not having a requirement to be transmitted at specific transmit times; and a transmit controller configured to receive a packet directed to the first queue, determine whether the packet directed to the first queue is a type of packet that requires transmission at a specific transmit time, and in response to determining that the packet directed to the first queue is a type of packet that requires transmission at a specific transmit time, i) suspend an ongoing transmission of a preemptable packet from the second queue that would prevent transmission of the packet from the first queue at the specific transmit time via the network interface and ii) cause the packet in the first queue to be transmitted at the specific transmit time via the network interface.

In another embodiment, a method for transmitting packets includes: receiving a packet at a transmit controller of the network device, the packet directed to a first queue configured to queue express packets to be transmitted via a network interface of the network device, the express packets including one or more types of packets that require transmission at specific transmit times; determining, by the transmit controller, whether the packet directed to the first queue is a type of packet that requires transmission at a specific transmit time; and in response to determining that the packet directed to the first queue is a type of packet that requires transmission at a specific transmit time, i) suspending, by the transmit controller, an ongoing transmission of a preemptable packet from a second queue that would prevent transmission of the packet from the first queue at the specific transmit time via the network interface, the second queue configured to queue preemptable packets that are to be transmitted via the network interface of the network device, the preemptable packets not having a requirement to be transmitted at specific transmit times and ii) causing, by the transmit controller, the packet in the first queue to be transmitted at the specific transmit time via the network interface.

### BRIEF DESCRIPTION OF THE DRAWINGS

FIG. 1 is a block diagram of an example network device configured to transmit certain packets at specific transmit times via an express channel of the network device, according to an embodiment.

FIG. 2 is a block diagram of an example network device configured to transmit certain packets at specific transmit times via an express channel of the network device, according to another embodiment.

FIG. 3 is a flow diagram of an example method for transmitting packets via a network interface of a network device, according to an embodiment.

### DETAILED DESCRIPTION

In embodiments described below, a network device includes an express channel (e.g., having an express queue) and a preemptable channel (e.g., having a preemptable queue) configured to transmit packets via a network interface of the network device. The express channel is used for transmission of express packets via the network interface of the network device and the preemptable channel is used for transmission of preemptable packets via the network interface. Express packets are generally packets that have certain timing requirements, such as packets that require low latency and/or low resident times in the network device, in various embodiments. In an embodiment, express packets include one or more packet packets that require transmission from the network device at specific transmit times. As an example, express packets include forward timestamped packets, such as precision time protocol (PTP) packets, that require transmission at specific transmit times corresponding to timestamps inserted in the packets. On the other hand, preemptable packets generally do not have timing requirements such as low latency and/or low resident times in the network device and do not have a requirement to be transmitted at specific transmit times via the network interface of the network device, in an embodiment.

In an embodiment, to ensure an express packet that requires transmission at a specific transmit time can be transmitted from the express queue at the specific transmit time without being blocked by any other express packet in the express queue at the specific transmit time, the network device dispatches the express packet that requires transmission at a specific transmit time to the express queue when the express queue is empty so that the express packet is placed directly at the head of the express queue. Further, to ensure that if an express packet that is placed directly at the head of the express queue is a type of packet that requires transmission at a specific transmit time, the express packet is not prematurely transmitted from the express queue before to the specific transmit time, a transmit controller of the network device proactively stops transmission from the express queue when the express queue becomes empty. Then, when the transmit controller receives a packet directed to the express queue, the transmit controller determines whether the packet directed to the express queue is a type of packet (e.g., a forward-timestamped packet) that requires transmission at a specific transmit time from the network device. In response to determining that the packet directed to the express queue is a type of packet that requires transmission at a specific transmit time from the network device, the transmit controller holds transmission from the express queue until the specific transmit time. Then, at the specific transmit time, the transmit controller suspends any ongoing transmission from the preemptable queue and causes the packet to be transmitted from the express queue, in an embodiment.

On the other hand, in response to determining that the packet directed to the express queue is not a type of packet that requires transmission at a specific transmit time from the network device, the transmit controller does not hold transmission from the express queue until any specific transmit time and does not necessarily suspend transmission from the preemptable queue at any specific transmit time. For example, the transmit controller immediately releases transmission from the express queue so that the packet can be immediately transmitted from the network device, preempting any ongoing transmission from the preemptable queue of the network device, or is transmitted when preemption of transmission from the express queue occurs according to a cyclical or other suitable preemption schedule, for example. Thus, by proactively stopping transmission from the express queue without necessarily suspending transmission from the preemptable queue, the transmit controller ensures that transmission of a packet that requires transmission at a specific transmit time occurs at the specific transmit time without unnecessarily negatively effecting wire speed of transmission of preemptable packets from the network device and without causing significant delays for express packets that require transmission at specific transmit times from the network device, in at least some embodiments.

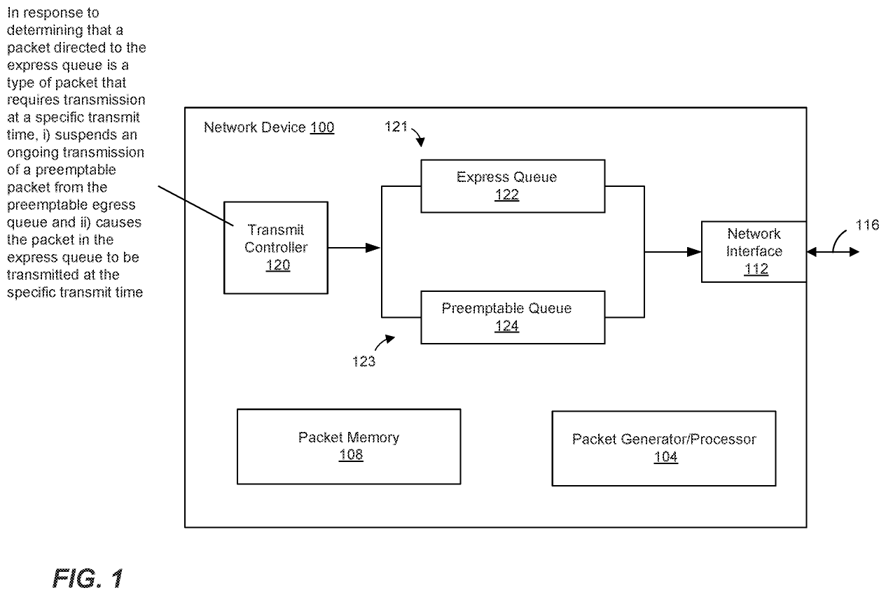

FIG. 1 is a block diagram of an example network device 100 that is configured to transmit certain packets at specific transmit times via an express channel of the network device, according to an embodiment. In some embodiments, the network device 100 is an endpoint device that generates and transmits packets in a communication network. Illustrative examples of endpoint devices include a personal computer, a tablet computer, a mobile communication device, a sensor device, an industrial device in a factory, etc. In other embodiments, the network device 100 is a forwarding device that receives packets and forwards the packets via a plurality of network interfaces such as ports. Illustrative examples of forwarding devices include switches, routers, bridges, repeaters, access points, etc.

The network device 100 includes a packet generator and/or packet processor 104. For example, when the network device 100 is an endpoint device, the network device 100 includes a packet generator 104 that generates the packets for transmission, according to an embodiment. As another example, when the network device 100 is a forwarding device, the network device 100 includes a packet processor 104 that analyzes packets received by the network device 100 to determine network interfaces (e.g., ports) of the network device 100 via which the packets are to be transmitted, according to an embodiment. In some embodiments, the packet processor 104 modifies the packets received by the network device 100, such as modifying headers of packets received by the network device 100.

The network device 100 includes a packet memory 108 configured to store packets, or at least packet payloads, after the packets are generated by the packet generator and/or packet processor 104 and/or while the packets are being processed by the packet generator and/or packet processor 104. In various embodiments, the packet memory 108 comprises a random access memory (RAM) or another suitable type of memory device. In an embodiment, the packet memory 108 stores packets while the packet generator and/or packet processor 104 processes packet descriptors, or other data units, associated with the packets. The packets, or at least the packet payloads, that are stored in the packet memory 108 are then retrieved from the packet memory 108 for transmission from the network device 100. In some embodiments, one or more processing operations are performed on a packet after the packet is retrieved from the packet memory 108 and before the packet is transmitted from the network device 100. For example, the network device 100 modifies a header of the packet after the packet is retrieved from the packet memory 108 and prior to transmission of the packet. In another embodiment, the packet memory 108 stores payloads of packets while the packet generator and/or packet processor 104 processes headers of the packets, including performing any necessary modifications to the headers of the packets. The packet payloads are then retrieved from the packet memory 108 and combined with the payloads of the corresponding packets to form processed packets for transmission from the network device 100.

The network device 100 also includes a network interface 112 coupled to a communication link 116. In an embodiment, the communication link 116 is a fiber optical link and the network interface 112 comprises an optical port. In another embodiment, the communication link 116 is a wired communication link and the network interface 112 comprises an Ethernet port. In another embodiment, the communication link 116 is a wireless communication link and the network interface 112 comprises a wireless network interface. In other embodiments, other suitable network interfaces 112 and communication links 116 are used. In various embodiments, the network interface 112 includes one of, or any suitable combination of two or more of, a digital-to-analog converter (DAC), a digital-to-optical converter, an amplifier, a modulator, etc. (not shown), to covert a digital signal corresponding to a packet to an analog/optical signal suitable for transmission via the communication link 116.

In an embodiment, the packet generator and/or packet processor 104 is configured to generate and/or process packets of different types of packets. For example, the packet generator and/or packet processor 104 is configured to generate and/or process packets that relatively more time-sensitive (sometime referred to herein as “express packets”) and other packets that are relatively less time-sensitive (sometimes referred to herein as “preemptable packets”), in an embodiment. Generally, express packets generated and/or processed by the packet generator and/or packet processor 104 are more time sensitive and/or higher priority as compared to the preemptable packets generated and/or processed by the packet generator and/or packet processor 104, in an embodiment. For example, express packets generated and/or processed by the packet generator and/or packet processor 104 include types of packets that require relatively low latency, relatively low residence times, relatively low packet delay variation and/or jitter, etc., in various embodiments. On the other hand, preemptable packets generated and/or processed by the packet generator and/or packet processor 104 generally are less time sensitive as compared to express packets generated and/or processed by the packet generator and/or packet processor 104. Further, the preemptable packets do not have a requirement to be transmitted at any specific transmit time from the network device 100, in an embodiment. As will be explained in more detail below, transmission of a preemptable packet via a network interface (e.g., the network interface 112) of the network device 100 is sometimes preempted to allow for transmission of one or more express packets via the network interface 112 of the network device 100, in an embodiment.

With continued reference to FIG. 1, express packets generated and/or processed by the packet generator and/or packet processor 104 include one or more types of packets that require transmission from the network device (e.g., via the network interface 112 and the network link 116) at specific transmit times, in an embodiment. For example, the express packets generated and/or processed by the packet generator and/or packet processor 104 include timing packets, such as precision time protocol (PTP) packets, that are forward timestamped by the network device 100, and such express packets require transmission from the network device 100 at specific transmit times corresponding to the timestamps inserted in the packets, in an embodiment. In other embodiments, the express packets generated and/or processed by the packet generator and/or packet processor 104 include one or more types of packets that require transmission from the network device (e.g., via the network interface 112 and the network link 116) at specific transmit times for reasons other than transmission at a specific transmit time corresponding to a timestamp inserted in the packet. The express packets generated and/or processed by the packet generator and/or packet processor 104 also include express packets that do not have a requirement to be transmitted at specific transmit times from the network device 100, but that nonetheless require time sensitive and/or time aware transmission from the network device 100. In various embodiments, express packets that do not have a requirement to be transmitted at specific transmit times from the network device 100 include express packets that are to be transmitted using a cyclical or other suitable scheduling scheme for preempting ongoing transmissions of preemptable packets from the network device 100. In some embodiments, such express packets include time sensitive packets for which a bounded delay requirement must be satisfied but for which transmission at any specific transmit time is not required.

In an embodiment, packets generated and/or processed by the packet processor 104 are provided to a transmit controller 120 for subsequent transmission via the network interface 112. The transmit controller 120 is configured to control transmission of packets to the network interface 112 via a first channel 121 (sometimes referred to herein as “express channel 121”) having a first express queue 122 (sometimes referred to herein as “express queue 122) and a preemptable channel 123 (sometimes referred to herein as “preemptable channel 123”) having a second queue 124 (sometimes referred to herein as “preemptable queue 122), in an embodiment. The express queue 122 is configured to queue express packets for transmission via the network interface 112, in an embodiment. In an embodiment, the express queue 122 is configured to queue express packets of one or more types of packets that require transmission at specific transmit times from the network device 100 as well as express packets that do not require transmission at specific transmit times from the network device 100. In another embodiment, the express queue 122 is configured to queue only packets that require transmission at specific transmit times from the network device 100. The preemptable queue 124, on the other hand, is configured to queue preemptable packets that do not require transmission at specific transmit times from the network device 100. Preemptable packets that the preemptable queue 124 is configured to queue are generally less time sensitive than express packets that the express queue 122 is configured to queue, in an embodiment. Thus, an ongoing transmission of a relatively less time-sensitive preemptable packet from the preemptable queue 124 can be preempted for transmission of one or more relatively more time-sensitive express packets from the express queue 122, in an embodiment.

In an embodiment, in order to allow an express packet that requires transmission at a specific transmit time via the network interface 112 to actually be transmitted at the specific transmit time from the express queue 122 via the network interface 112 without being blocked by any other express packet in the express queue 122, the network device 100 is configured to dispatch such express packet to the express queue 122 when the express queue 122 is empty so that the express packet is placed directly at the head of the express queue 122. In an embodiment, a processing unit of the network device 100 that is upstream from the transmit controller 120 (e.g., a processing unit that is part of the packet generator and/or packet processor 104) dispatches an express packet that requires transmission at a specific transmit time via the network interface 112 in response to determining that the express queue 122 is empty so that the express packet is placed directly at the head of the express queue 122. In another embodiment, the transmit controller 120 itself dispatches an express packet that requires transmission at a specific transmit time via the network interface 112 in response to determining that the express queue 122 is empty so that the express packet is placed directly at the head of the express queue 122. On the other hand, express packets that do not have a requirement to be transmitted at a specific transmit time via the network interface 112 are placed in the express queue 122 even if other express packets are currently queued in the express queue 122, i.e., such express packets are not necessary placed directly at the head of the express queue 122, in an embodiment.

In an embodiment, to ensure that if an express packet that requires transmission at a specific transmit time via the network interface 112 is placed at the head of the express queue 122, the express packet is not prematurely transmitted from the express queue 122 prior to the transmit controller 120 analyzing the express packet and determining whether or not the express packet is a type of packet that requires transmission at a specific transmit time from the express queue 122, the transmit controller 120 proactively stops transmission from the express queue 122 when the transmit controller 120 determines that the express queue 122 is empty. When the transmit controller 120 receives a packet directed to the express queue 122, the transmit controller 120 determines whether the packet is a type of packet that requires transmission at a specific transmit time from the network device 100. If the transmit controller 120 determines that the packet directed to the express queue 122 is a type of packet that requires transmission at a specific transmit time from the network device 100, the transmit controller 120 i) suspends ongoing transmission of one or more preemptable packets from the preemptable queue 124 that would prevent transmission of the packet from the express queue 122 at the specific transmit time and ii) causes the packet to be transmitted from the express queue 122 at the specific transmit time, in an embodiment.

For example, if the transmit controller 120 determines that the packet directed to the express queue 122 is a forward timestamped packet that requires transmission from the network device 100 at a specific transmit time corresponding to a timestamp embedded in the packet, the transmit controller 120 causes the packet to be transmitted from the express queue 122 at a specific transmit time corresponding to the timestamp embedded in the packet. In an embodiment, the transmit controller 120 causes the packet to be transmitted from the egress queue 122 by releasing transmission from the express queue 122 at the specific transmit time, or at a time determined based on the specific transmit time, so that transmission of the packet at the head of the express queue 122 is caused by a controller (not shown in FIG. 1) downstream of the transmit controller 120, such as a merge sublayer controller downstream of the transmit controller 120, at the specific transmit time.

In some embodiments, the transmit controller 120 does not immediately suspend ongoing transmission of one or more preemptable packets from the preemptable queue 124 in response to determining that a packet directed to the express queue 122 is a type of packet that requires transmission at a specific transmit time, for example if one or more preemptable packets can be transmitted from the preemptable queue 124 without delaying transmission of the packet from the express queue 122 at the specific transmit time. For example, the transmit controller 120 determines a period of time between a current time and the specific transmit time, and determines that one or more preemptable packets can be transmitted in the period of time between a current time and the specific transmit time, without delaying transmission of the packet from the express queue 122 at the specific transmit time, in an embodiment. In some embodiments, the transmit controller 120 determines a number of preemptable packets that can be transmitted in the period of time between the current time and the specific transmit time. In response to determining that one or more preemptable packets can be transmitted in the period of time between the current time and the specific transmit time and/or a specific number number of preemptable packets that can be transmitted in the period of time between the current time and the specific transmit time, the transmit controller 120 delays suspension of transmission from the preemptable queue 124 to allow for transmission of the one or more preemptable packets (e.g., the specific number of preemptable packets) before the specific transmit time, in an embodiment.

In an embodiment, in response to determining that the packet directed to the express queue 122 is a type of packet that requires transmission at a specific transmit time, the transmit controller 122 i) holds transmission of the packet from the express queue 122 until the specific transmit time and ii) releases transmission of the packet from the express queue 122 at the specific transmit time or at a time determined based on the specific transmit time. The transmit controller also releases transmission from the preemptable queue 124 at the specific transmit time, or at a time determined based on the specific transmit time, so that a preempted transmission from the preemptable queue 124 can be resumed (e.g., by a merge sublayer controller downstream the transmit controller 120) after transmission of the packet from the express queue 122 at the specific transmit time, in an embodiment.

On the other hand, if the transmit controller 120 determines that the packet directed to the express queue 122 is not a type of packet that requires transmission at a specific transmit time from the network device 100, then the transmit controller 120 releases transmission from the express queue 122 without waiting for any specific transmit time. For example, in response to determining that the packet directed to the express queue 122 is not a type of packet that requires transmission from the network device 100 at a specific transmit time, the transmit controller 120 releases the express queue 122 for immediate transmission of the packet (e.g., by a merge sublayer controller downstream the transmit controller 120). Further, in response to determining that the packet directed to the express queue 122 is not a type of packet that requires transmission at a specific transmit time from the network device 100, the transmit controller 120 does not necessarily suspend an ongoing transmission of a preemptable packet from the preemptable queue 124, in an embodiment. In this case, because the packet does not have a requirement to be transmitted at a specific transmit time, the transmit controller 120 does not suspend transmission from the preemptable queue 124 to allow for transmission of the packet at a specific transmit time, in an embodiment. The express packet is then immediately transmitted via the network interface 112, preempting any ongoing transmission from the preemptable queue 124, or is transmitted when preemption of transmission from the preemptable queue 124 occurs according to a cyclical or other suitable preemption schedule, for example, in various embodiments. One or more preemptable packets from the preemptable queue 124 are thus transmitted prior to transmission of the express packet that does not require transmission from the express queue 122 at a specific transmit time, as dictated by the cyclical or other suitable preemption schedule, in some embodiments. In these ways, by proactively stopping transmission from the express queue 122 upon determining that the express queue 122 is empty without necessarily suspending transmission from the preemptable queue 124 before determining whether a packet directed to the express queue 122 is a type of packet that requires transmission at a specific transmit time from the network device 100, the transmit controller ensures that a packet that is placed at the head of the express queue 122 and that requires transmission at a specific transmit time from the network device 100 can actually be transmitted at the specific transmit time from the network device 100 without unnecessarily effecting transmission of preemptable traffic in the preemptable queue 124 from the network device 100, in at least some embodiments.

Although one network interface 112 and one communication link 116 is illustrated in FIG. 1, in other embodiments, the network device 100 comprises a plurality of network interfaces 112 coupled to respective communication links 116. In an embodiment in which the network device 100 comprises a plurality of network interfaces 112 coupled to respective communication links 116, the network device 100 includes a respective transmit controller 120, a respective express channel 121 and a respective preemptable channel 123 for respective ones of the plurality of network interfaces 112. In another embodiment in which the network device 100 comprises a plurality of network interfaces 112 coupled to respective communication links 216, the network device 200 includes a respective express channel 121 and a respective preemptable channel 123 for respective ones of the plurality of network interfaces 112, whereas the transmit controller 120 is configured to control transmission of packets that are transmitted via respective ones of multiple (e.g., all) of network interfaces 112 among the plurality of network interfaces 112.

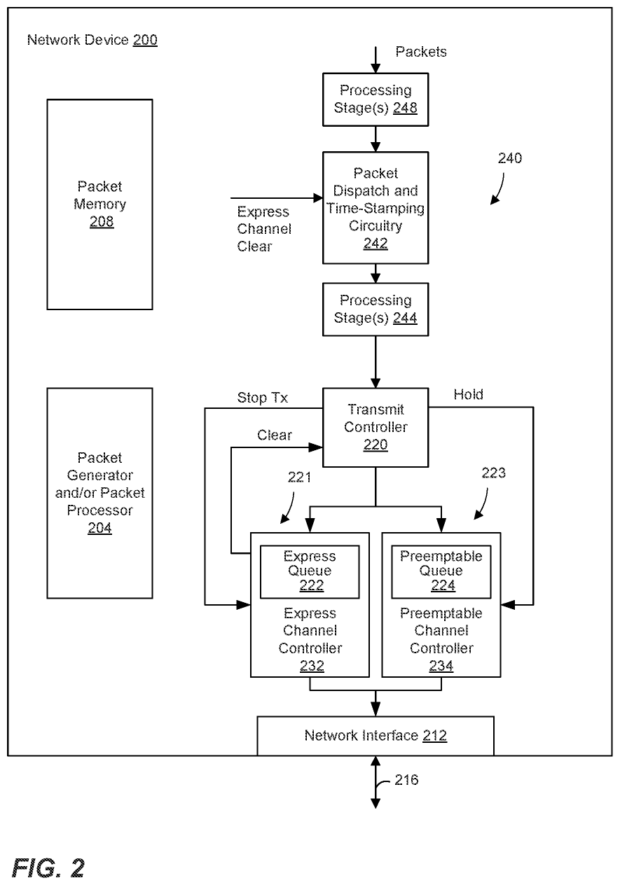

FIG. 2 is a simplified diagram of another example network device 200 configured to transmit express packets of certain types that require transmission at specific transmit times from the network device 200, according to an embodiment. The network device 200 is described in the context of transmission of forward timestamped packets at specific transmit times corresponding to the forward timestamps inserted in the packets. It is noted, however, that the network device 200 is configured to transmit express packets of other suitable types that require transmission at specific transmit times, in other embodiments.

The network device 200 is similar to the network device 100 of FIG. 1, and includes like-numbered elements that are the same or similar to the corresponding element of the network device 100 of FIG. 1. For example, the network device 200 includes a packet generator and/or processor 204 that is the same as or similar to the packet generator and/or packet processor 104 of the network device 100 of FIG. 1 and a packet memory 208 that is the same as or similar to the packet memory 108 of the network device 100 of FIG. 1. The network device 200 also includes a network interface 212 that is the same as or similar to the network interface 112 of the network device 100 of FIG. 1, and the network interface 212 is coupled to a link 216 that is the same as or similar to the network link 116 of FIG. 1.

The network interface device 200 also includes a transmit controller 220 that is the same as or similar to the transmit controller 120 of the network device 100 of FIG. 1. The transmit controller 220 is configured to control transmission of packets via the network interface 212 via an express channel 221 that is the same as or similar to the express channel 121 of the network device 100 of FIG. 1 and a preemptable channel 223 that is the same as or similar to the preemptable channel 123 of the network device 100 of FIG. 1. In the embodiment of FIG. 2, the express channel 221 comprises an express channel controller 232 configured to maintain an express queue 222 that is the same as or similar to the express queue 122 of the network device 100 of FIG. 1. Similarly, the preemptable channel 223 comprises a preemptable channel controller 234 configured to maintain the preemptable queue 224 that is the same as or similar to the preemptable queue 124 of the network device 100 of FIG. 1.

In an embodiment, the express channel controller 232 is an express media access controller (eMAC) that operates at a MAC layer implemented in the network device 200, and the express channel controller 232 is sometimes referred to herein as eMAC 232. Similarly, in an embodiment, the preemptable channel controller 234 is a preemptable media access controller (pMAC) that operates at the MAC layer implemented in the network device 200, and the preemptable channel controller 234 is sometimes referred to herein as pMAC 234. In other embodiments, the express channel controller 232 and/or the preemptable channel controller 234 operate at a layer other than a MAC layer implemented by the network device 200.

As discussed above, the network device 200 includes the packet generator and/or packet processor 204 that is the same as or similar to the packet generator and/or packet processor 104 of the network device 100 of FIG. 1. The packet generator and/or packet processor 204 is configured to generate and/or process packets for transmission via the network interface 222 of the network device 200 in manners same as or similar to the packet generator and/or packet processor 104 of FIG. 1, in an embodiment. The network device 200 also includes a plurality of processing stages 240 configured to perform further processing of packets generated and/or processed packets the packet generator and/or packet processor 204 prior to transmission of the packets via the network interface 222. The processing stages 240 are generally configured to perform processing operations on packets that are otherwise ready for transmission from the network device 200, in an embodiment. In an embodiment, the processing stages 240 are configured to perform processing operations on packets after the packets are retrieved from the packet memory 208. In another embodiment, the processing stages 240 are configured to process packet headers while corresponding packet payloads are stored in the packet memory 208. In this embodiment, after the packet headers are processed by the processing stages 140 and prior to transmission of the packets from the network device 200, payloads corresponding to the packet headers are retrieved from the packet memory 208 and combined with the packet headers.

The plurality of processing stages 240 are arranged in series, for instance as a processing pipeline, and process packets in an order, according to an embodiment. In some embodiments, the plurality of processing stages 240 also includes one or more parallel branches (not shown) in which respective processing stages selectively operate on a packet depending on the branch via which the packet traverses. Further, although the plurality of processing stages 240 are illustrated in FIG. 2 as being separate from the packet generator and/or packet processor 204, at least some of the processing stages 240 are part(s) of the packet generator and/or packet processor 204, in some embodiments.

The plurality of processing stages 240 includes packet dispatch and time stamping circuitry 242 that is configured to modify a packet to embed a timestamp in the packet. In an embodiment, the timestamp is a forward timestamp that corresponds to a future time at which the packet is to be transmitted via the network interface 212 from the network device 200, the future time being after a current time at which the timestamp is embedded by the packet dispatch and time stamping circuitry 242 in the packet. The packet dispatch and time stamping circuitry 242 is configured to dispatch the packet, with the timestamp embedded in the packet, to be queued in the express queue 222 for subsequent transmission via the express channel 221 from the network device 200, in an embodiment. Using the express channel 221, rather than the preemptable channel 222, for transmission of timestamped packets reduces queuing times that the timestamped packets experience in the network device 200 and facilitates minimization of packet delay variation (PDV) that can negatively affect accuracy of timing synchronization, in at least some embodiments.

In an embodiment, in order to allow the packet to be transmitted via the express channel 221 at the specific transmit time corresponding to the timestamp inserted in the packet without being blocked by any other express packet being transmitted from the express queue 222 of the express channel 221 at the specific transmit time, the packet dispatch and time stamping circuitry 242 dispatches the packet to be queued in the express queue 222 in response to determining that the express queue 222 is empty so that the packet is placed directly at the head of the express queue 222. In various embodiments, the packet dispatch and time stamping circuitry 242 is configured to determine that the express queue 222 is empty based on a clear channel signal that the packet dispatch and time stamping circuitry 244 receives from the express channel controller 232 or based on credits that the packet dispatch and time stamping circuitry 242 receives from the express channel controller 232. For example, in an embodiment, the packet dispatch and time stamping circuitry 242 is configured to determine that the express queue 222 is empty when all credits for the express queue 222 are received by the packet dispatch and time stamping circuitry 242 from the express channel controller 232. In other embodiments, the packet dispatch and time stamping circuitry 244 is configured to determine that the express queue 222 of the express channel 221 is empty in other suitable manners.

In an embodiment, prior to dispatching the packet to be queued in the express queue 222, the packet dispatch and time stamping circuitry 242 determines the specific transmit time at which the packet is to be transmitted via the network interface 212 and inserts the specific transmit time as the timestamp in the packet. In an embodiment, the packet dispatch and time stamping circuitry 242 determines the specific transmit time by adding a time offset to a current time at which the packet dispatch and time stamping circuitry 242 inserts the timestamp into the packet. The time offset corresponds to a maximum latency of one or more processing stages in the plurality of processing stages 240 that are to process the packet after the packet dispatch and time stamping circuitry 242 and additional delay corresponding to a latency caused by transmission of a maximum length segment of a preemptable packet prior to stopping an ongoing transmission from the preemptable queue 224 to allow for transmission of the packet from the express queue 222, in an embodiment. As just an example, the preemptable channel controller 234 is configured to transmit a segment of at most 128 bytes after being instructed to suspend preemptable transmission from the preemptable queue 224, and thus the time offset includes a latency caused by transmission of a 128 Byte segment of a preemptable packet prior to suspending transmission, in an embodiment. In other embodiments, the maximum length of a preemptable segment that can be transmitted from the preemptable queue 224 prior to suspension of transmission from the preemptable queue 224 is a suitable length different from 128 bytes, and the time offset includes a latency caused by transmission of a segment of the suitable length different from 128 bytes.

In an embodiment, the packet dispatch and time stamping circuitry 242 does not timestamp every packet that the packet dispatch and time stamping circuitry 242 receives, e.g., the packet dispatch and time stamping circuitry 242 selectively timestamps packets. For example, the packet dispatch and time stamping circuitry 242 is configured to timestamp a packet in response to determining that the packet is a timing packet, such as a PTP packet. In an embodiment, the packet dispatch and time stamping circuitry 242 is configured to analyze information in a packet header or a packet descriptor associated with the packet to determine whether to timestamp the packet. If the packet dispatch and time stamping circuitry 242 determines that the packet is not to be timestamped, the packet dispatch and time stamping circuitry 242 does not timestamp the packet and dispatches the packet without holding the packet (e.g., immediately dispatches the packet).

The packet dispatch and time stamping circuitry 242 is also configured to generate timing information, separate from the timestamp in the packet, that indicates the specific transmit time, according to an embodiment. The timing information (separate from the timestamp in the packet) is used to inform the transmit controller 220 of the specific transmit time at which the packet is to be transmitted, in an embodiment. In particular, the transmit controller 220 uses the timing information to determine when a packet is to be released from the express queue 222, as will be described below, in an embodiment.

In an embodiment, the packet dispatch and time stamping circuitry 242 outputs the timing information separately from the packet, e.g., via a first output of the packet dispatch and time stamping circuitry 242, which is separate from a second output of the packet dispatch and time stamping circuitry 242 that outputs the packet that includes the timestamp. In another embodiment, the timing information is appended to the packet, e.g., in a tag appended to the packet, the tag being removed from the packet prior to transmitting the packet via the network interface 212 so that the tag is not transmitted via the network interface 212.

In some embodiments, the packet dispatch and time stamping circuitry 242 does not generate timing information, separate from the timestamp in the packet, that indicates the specific transmit time to inform the transmit controller 220 of the specific transmit time. For example, the transmit controller 220 is configured to determine the specific transmit time at which the packet is to be transmitted by locating the timestamp embedded in the packet and determining the specific transmit time based on the timestamp embedded in the packet, in some embodiments.

The plurality of processing stages 240 includes one or more post-timestamping processing stages 244 between the packet dispatch and time stamping circuitry 242 and the transmit controller 220. In an embodiment, the one or more post-timestamping processing stages 244 includes authentication circuitry that is configured to generate authentication information for contents of the packet, including the timestamp embedded in the packet by the packet dispatch and time stamping circuitry 242. In an embodiment, the authentication circuitry is configured to embed the authentication information in the packet. In another embodiment, the authentication circuitry is configured to embed the authentication information in a subsequent packet. In another embodiment, the one or more post-timestamping processing stages 244 additionally or alternatively includes encryption circuitry that is configured to encrypt contents of the packet, including the timestamp embedded in the packet by the packet dispatch and time stamping circuitry 242. In other embodiments, the one or more post-timestamping processing stages 244 additionally or alternatively includes other suitable circuitry that performs other suitable processing of the packet.

The transmit controller 220 is configured to receive a packet dispatched by the packet dispatch and time stamping circuitry 242 and to appropriately direct the packet for transmission via the express channel 221 or the preemptable channel 223. For example, the transmit controller 220 is configured to determine whether the packet is an express packet or a preemptable packet and to provide the packet to the express channel controller 232 in response to determining that the packet is an express packet or the preemptable channel controller 234 in response to determining that the packet is a preemptable packet. In an embodiment, the transmit controller 220 is also configured to determine whether the packet is a type of packet that requires transmission at a specific transmit time, in an embodiment. For example, the transmit controller 120 is configured to determine whether the packet is a timing packet, such as a PTP packet, that includes a future timestamp and that is to be transmitted at a specific transmit time corresponding to the future timestamp in the packet. In an embodiment, the transmit controller 220 is configured to analyze information in a packet header or a packet descriptor associated with the packet to determine whether the packet is an express packet or a preemptable packet and/or whether the packet is a type of packet that requires transmission at a specific transmit time.

As discussed above, the packet dispatch and time stamping circuitry 242 is configured to dispatch a packet that requires transmission at a specific transmit time when the express queue 222 is empty so that when the packet is provided to the express channel controller 232, the express channel controller 232 will place the packet directly at the head of the express queue 222. Thus, when the transmit controller 120 determines that the packet is a type of packet that requires transmission at a specific transmit time and provides the packet to the express channel controller 232, the express channel controller 232 places the packet directly at the head of the express queue 222, in an embodiment.

In an embodiment, the transmit controller 220 is configured to proactively instruct the express channel controller 232 to stop transmission from the express queue 222 in response to determining that the express queue 222 has become empty and prior to receiving a packet dispatched by packet dispatch and time stamping circuitry 242 and determining whether the packet is a type of packet that requires transmission at a specific transmit time. For example, the transmit controller 220 is configured to assert a stop transmission (Stop Tx) signal provided to the express channel controller 232 to proactively instruct the express channel controller 232 to stop transmission from the express queue 222 in response to determining that the express queue 222 has become empty and prior to receiving a packet dispatched by packet dispatch and time stamping circuitry 242 and determining whether the packet is a type of packet that requires transmission at a specific transmit time. In various embodiments, the transmit controller 220 is configured to determine that the express queue 222 is empty based on a clear channel signal that the transmit controller 220 receives from the express channel controller 232 or based on credits that the transmit controller 220 receives from the express channel controller 232. For example, in an embodiment, the transmit controller 220 is configured to determine that the express queue 222 is empty when all credits for the express queue 222 are received by the transmit controller 220 from the express channel controller 232. In other embodiments, the transmit controller 220 is configured to determine that the queue 222 is empty in other suitable manners. Proactively instructing the express channel controller 232 to stop transmission from the express queue 222 when the express queue 222 becomes empty ensures that if a packet directed to the express queue 222 is a type of packet that requires transmission at a specific transmit time, the packet will not be prematurely transmitted from the express queue 222 before the specific transmit time, in an embodiment.

In an embodiment, if the transmit controller 220 determines that a packet directed to the express queue 222 is a type of packet that requires transmission at a specific transmit time (e.g., a timing packet that is to be transmitted at a specific transmit time corresponding to a timestamp inserted in the packet), the transmit controller 220 instructs the preemptable channel controller 234 to suspend an ongoing transmission of a preemptable packet from the preemptable queue 224. For example, the transmit controller 220 asserts a hold signal 238 to instruct the preemptable channel controller 234 to suspend an ongoing transmission of a preemptable packet from the preemptable queue 224. In an embodiment, when the preemptable channel controller 234 is instructed to suspend transmission from the preemptable queue 224, the preemptable channel controller 234 transmits at most a maximum-length segment of a preemptable packet from the preemptable queue 224 prior to suspending transmission from the preemptable queue 224. In an embodiment, the maximum length of a segment that can be transmitted from the preemptable queue 224 prior to suspension of transmission from the preemptable queue 224 is 128 bytes. In another embodiment, the maximum length of a preemptable segment that can be transmitted from the preemptable queue 224 prior to suspension of transmission from the preemptable queue 224 is a suitable length different from 128 bytes. Upon transmission of at most the segment of the maximum length, transmission of the preemptable packet is suspended, in an embodiment.

The transmit controller 220 then causes the packet to be transmitted from the express queue 222 at the specific transmit time, in an embodiment. In an embodiment, the transmit controller 220 causes the packet to be transmitted from the egress queue 222 by releasing transmission from the express queue 222 at the specific transmit time, or at a time determined based on the specific transmit time, so that transmission of the packet at the head of the express queue 222 is caused by a controller (not shown in FIG. 2) downstream of the transmit controller 220, such as a merge sublayer controller downstream of the express channel controller 232 and the preemptable channel controller 234, at the specific transmit time. In an embodiment, the transmit controller 222 holds transmission of the packet from the express queue 122 until the specific transmit time, or a time determined based on the specific transmit time, and releases transmission of the packet from the express queue 122 at the specific transmit time or the time determined based on the specific transmit time. For example, the transmit controller 220 is configured to de-assert the stop TX signal, provided to the express channel controller 232, at the specific transmit time, or at the time determined based on the specific transmit time, in an embodiment. The transmit controller also releases transmission from the preemptable queue 224 at the specific transmit time, or at a time determined based on the specific transmit time, so that a preempted transmission from the preemptable queue 224 can be resumed (e.g., by a merge sublayer controller downstream of the express channel controller 232 and the preemptable channel controller 234) after transmission of the packet from the express queue 222 at the specific transmit time, in an embodiment. For example, the transmit controller 220 is configured to de-assert the hold signal, provided to the preemptable channel controller 234, at the specific transmit time, or at the time determined based on the specific transmit time, in an embodiment.

The transmit controller 220 is configured to determine the specific transmit time at which the packet is to be transmitted based on the timing information received from the packet dispatch and timestamping circuitry 242, in an embodiment. In another embodiment, the transmit controller 220 is configured to determine the specific transmit time at which the packet is to be transmitted by locating the timestamp embedded in the packet and determining the specific transmit time based on the timestamp embedded in the packet. In some embodiments, the specific transmit time determined for transmission of the packet by the packet dispatch and timestamping circuitry 242 is adjusted with respect to the timestamp embedded in the packet. For example, to account for a known delay (e.g., a fixed, known delay) after the express queue 222 (e.g., including a fixed, known delay through the network interface 212), the packet dispatch and timestamping circuitry 242 adjusts the specific transmit time to be earlier than the timestamp embedded in the packet to account for the known delay, e.g., through the network interface 212. As another example, the specific transmit time determined by the packet dispatch and timestamping circuitry 242 corresponds to the timestamp embedded in the packet, and the transmit controller 220 causes the packet to be transmitted at an adjusted specific transmit time that is earlier than the timestamp embedded in the packet to account for the known delay, e.g., through the network interface 212. In other embodiments, the specific transmit time determined by the packer dispatch and timestamping circuitry 242 is not adjusted with respect to the timestamp embedded in the packet.

Referring back to the transmit controller 220, if the transmit controller 220 determines that the packet is not a type of packet that requires transmission at a specific transmit time, then the transmit controller 220 releases transmission from the express queue 222 without waiting for any specific transmit time. For example, the transmit controller 220 releases transmission from the express queue 222 (e.g., by de-asserting the stop TX signal provided to the express channel controller 232) immediately or as soon as possible upon determining that the packet is not a type of packet that requires transmission at a specific transmit time. In this case, because the packet does not have a requirement to be transmitted at a specific transmit time, the transmit controller 220 does not suspend transmission from the preemptable queue 224 to allow for transmission of the packet at a specific transmit time from the express queue 222. The packet is then immediately transmitted from the express queue 222, preempting any ongoing transmission from the preemptable queue 224, or is transmitted when preemption of transmission from the preemptable queue 124 occurs according to a cyclical or other suitable preemption schedule, for example, in various embodiments. Proactively stopping transmission from the express queue 222 upon determining that the express queue is empty without proactively suspending transmission from the preemptable queue 224 allows the transmit controller 220 to ensure that a packet that is placed directly at the head of the express queue 222 and that requires transmission at a specific transmit time via the network interface 212 can actually be transmitted at the specific transmit time without unnecessarily effecting transmission of preemptable traffic via the network interface 212, in at least some embodiments.

In some embodiments, the plurality of processing stages 240 includes one or more processing stages 248 prior to the packet dispatch and time stamping circuitry 242. In an embodiment, one of the one or more pre-timestamping processing stages 248 includes a DMA circuit that reads packets from the memory 208 and provides the packets to the plurality of processing stages 240. In another embodiment, the packet generator and/or packet processor 104 provides the packet, or a packet descriptor and/or packet header associated with the packet, to the plurality of processing stages 240.

Although one network interface 212 and one communication link 212 is illustrated in FIG. 2, in other embodiments, the network device 200 comprises a plurality of network interfaces 212 coupled to respective communication links 216. In an embodiment in which the network device 200 comprises a plurality of network interfaces 212 coupled to respective communication links 216, the network device 200 includes a respective plurality of processing stages 240 (e.g., each including a packet dispatch and timestamping circuitry 244), a respective transmit controller 220, a respective express channel controller 232 (e.g., including a respective express queue 222), and a respective preemptable channel controller 234 (e.g., including a respective preemptable queue 224) for respective ones of the plurality of network interfaces 212. In another embodiment in which the network device 200 comprises a plurality of network interfaces 212 coupled to respective communication links 216, the network device 200 includes a respective express channel controller 232 (e.g., including a respective express queue 222), and a respective preemptable channel controller 234 (e.g., including a respective preemptable queue 224) for respective ones of the plurality of network interfaces 212, whereas the plurality of processing stages 240 and the transmit controller 220 are configured to, respectively, process packets and control transmission of packets, that are transmitted via respective ones of multiple (e.g., all) of network interfaces 212 among the plurality of network interfaces 212.

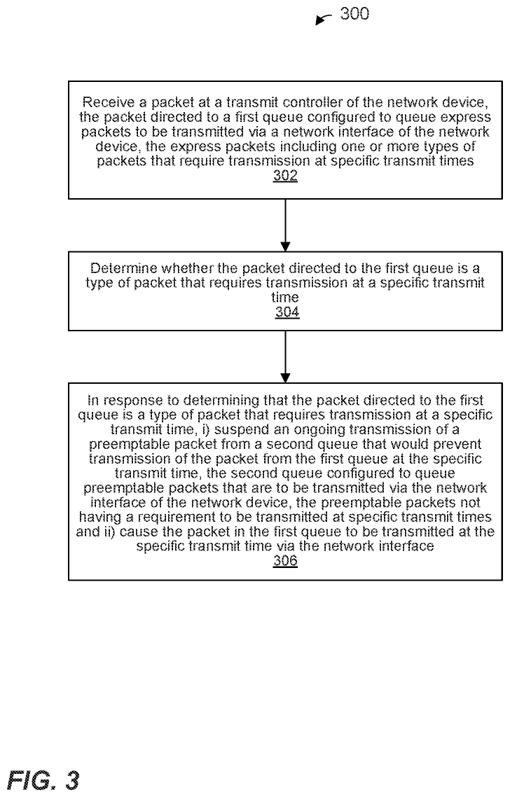

FIG. 3 is a flow diagram of an example method 300 for transmitting packets, according to an embodiment. The method 300 is implemented by the network device 100 of FIG. 1 or the network device 200 of FIG. 2, in some embodiments, and the method 300 is described with reference to FIGS. 1 and 2 for ease of explanation. For example, the method 300 is implemented by the transmit controller 120 of the network device 100 of FIG. 1 or the transmit controller 220 of the network device 200 of FIG. 2. In other embodiments, the method 300 is implemented by suitable network devices different than the network devices 100 and 200 of FIGS. 1 and 2.

At block 302, a transmit controller of a network device receives a packet. For example, the transmit controller 120 of the network device 100 of FIG. 1 receives the packet. As another example, the transmit controller 220 of the network device 200 of FIG. 2 receives the packet. In an embodiment, the packet is directed to a first queue maintained by the network device, wherein the first queue is configured to queue express packets to be transmitted via a network interface of the network device. In an embodiment, the packet is directed to the express queue 122 of FIG. 1. In another embodiment, the packet is directed to the express queue 222 of FIG. 2. In an embodiment, the first queue is configured one or more packet types, including one or more types of packets that require transmission at specific transmit times. For example, the first queue is configured to queue timestamped packets that require transmission at specific transmit time corresponding to timestamps embedded in the packets. In an embodiment, the first queue is configured to also queue packets that do not have a requirement to be transmitted at specific transmit times, but that nonetheless require time sensitive and/or time aware transmission from the network device.

At block 304, the transmit controller determines whether the packet received at block 302 is a type of packet that requires transmission at a specific transmit time. For example, the transmit controller determines whether the packet is a timestamped packet that requires transmission at a specific transmit time corresponding to a timestamp embedded in the packet. In other embodiments, the transmit controller determines whether the packet is a type of packet other than a timestamped packet that requires transmission at a specific transmit time other than a specific transmit time corresponding to a timestamp embedded in the packet.

At block 306, in response to determining that the packet received at block 302 is a type of packet that requires transmission at a specific transmit time, the transmit controller suspends an ongoing transmission a preemptable packet from a second queue that would prevent transmission of the packet from the first queue at the specific transmit time via the network interface. The second queue is configured to queue preemptable packets that are to be transmitted via the network interface of the network device, in an embodiment. The preemptable packets do not have a requirement to be transmitted at specific transmit times, in an embodiment. The second queue corresponds to the preemptable queue 124 of FIG. 1, in an embodiment. The second queue corresponds to the preemptable queue 224 of FIG. 2, in another embodiment. The second queue is configured to queue preemptable packets that do not have a requirement to be transmitted at specific transmit times, in an embodiment.

Also in response to determining that the packet received at block 302 is a type of packet that requires transmission at a specific transmit time, the transmit controller causes the packet in the first queue to be transmitted at the specific transmit time via the network interface. In an embodiment, prior to determining that the that the packet received at block 302 is a type of packet that requires transmission at a specific transmit time, the transmit controller proactively suspends transmission from the first queue to ensure that if the packet received at block 302 is a type of packet that requires transmission at a specific transmit time, the packet will not be prematurely transmitted from the first queue before the specific transmit time. Then, if the transmit controller determines that the packet received at block 302 is a type of packet that requires transmission at a specific transmit time, the transmit controller holds transmission of the packet from the first queue until the specific transmit time and causes the packet to be transmitted by releasing transmission from the first queue at the specific transmit time.

On the other hand, if the transmit controller determines that the packet received at block 302 is not a type of packet that requires transmission at a specific transmit time, the transmit controller does not hold transmission of the packet from the first queue until any specific transmit time. For example, the transmit controller immediately releases transmission from the first queue. Moreover, if the transmit controller determines that the packet received at block 302 is not a type of packet that requires transmission at a specific transmit time, the transmit controller does not suspend transmission from the second queue, in an embodiment. In various embodiments, the packet is immediately transmitted from the first queue, preempting any ongoing transmission from the second queue, or is transmitted from the first queue when preemption of transmission from the second queue occurs according to a cyclical or other suitable preemption schedule, for example. Proactively suspending transmission from the first queue without necessarily suspending transmission from the second queue ensures that a packet in the first queue that requires transmission at a specific transmit time can actually be transmitted at the specific transmit time without unnecessarily effecting transmission of preemptable traffic from the second queue, in at least some embodiments.

Embodiment 1: A network device, comprising: a first queue configured to queue express packets to be transmitted via a network interface of the network device, the express packets including one or more types of packets that require transmission at specific transmit times; a second queue configured to queue preemptable packets that are to be transmitted via the network interface of the network device, the preemptable packets not having a requirement to be transmitted at specific transmit times; and a transmit controller configured to receive a packet directed to the first queue, determine whether the packet directed to the first queue is a type of packet that requires transmission at a specific transmit time, and in response to determining that the packet directed to the first queue is a type of packet that requires transmission at a specific transmit time, i) suspend an ongoing transmission of a preemptable packet from the second queue that would prevent transmission of the packet from the first queue at the specific transmit time via the network interface and ii) cause the packet in the first queue to be transmitted at the specific transmit time via the network interface.

Embodiment 2: The network device of embodiment 1, further comprising: a packet dispatch controller configured to: in connection with transmission of a packet that requires transmission at a specific transmit time, temporarily hold dispatch of the packet if the first queue is not empty, while holding dispatch of the packet, determine that the first queue has become empty, and in response to determining that the first queue has become empty, dispatch the packet to be placed directly at a head of the first queue to ensure that transmission of the packet from the first queue at the specific transmit time will not be blocked by transmission of any other packet from the first queue at the specific transmit time.

Embodiment 3: The network device of embodiments 1 or 2, wherein the transmit controller is configured to: prior to determining whether the packet directed to the first queue is a type of packet that requires transmission at a specific transmit time, determine that the first queue has become empty, and in response to determining that the first queue has become empty, proactively suspend transmission from the first queue to ensure that if the packet directed to the first queue is a type of packet that requires transmission at a specific transmit time, the packet will not be prematurely transmitted from the network interface before the specific transmit time.

Embodiment 4: The network device of any of the embodiments 1-3, wherein the transmit controller is configured to, in response to determining that the packet directed to the first queue is a type of packet that requires transmission at a specific transmit time, i) hold transmission of the packet from the first queue until the specific transmit time and ii) release transmission of the packet from the first queue at the specific transmit time.

Embodiment 5: The network device of any of the embodiments 1-4, wherein the transmit controller is further configured to: at the specific transmit time, release transmission of preemptable packets from the second queue to enable resumption of transmission of packets from the second queue after transmission of the packet from the first queue at the specific transmit time.

Embodiment 6: The network device of embodiment 3, wherein the transmit controller is configured to, in response to determining that the packet directed to the first queue is not a type of packet that requires transmission at a specific transmit time, release transmission of the packet from the first queue without waiting until any specific transmit time.

Embodiment 7: The network device of any of the embodiments 1-6, wherein the transmit controller is configured to determine that the packet is a type of packet that requires transmission at a specific transmit time at least by determining that the packet is a timestamped packet that requires transmission at a specific transmit time corresponding to the timestamp inserted in the packet.

Embodiment 8: The network device of embodiment 7, further comprising timestamping circuitry configured to insert a timestamp into the packet, the timestamp corresponding to a specific transmit time at which the packet is to be transmitted via the network interface of the network device, the specific transmit time being offset from a current time at which the timestamp is inserted into the packet by a maximum amount of delay that can be experienced by the packet after the timestamping circuitry inserts the timestamp into the packet.

Embodiment 9: The network device of embodiment 8, wherein the timestamping circuitry is configured to determine the specific time at which the packet is to be transmitted from the network device by adding an offset to the current time, the offset accounting for i) a maximum latency that can be introduced by one or more processing stages configured to process the packet after the timestamp is inserted into the packet and before the packet is enqueued in the first queue and ii) an amount of time required for transmission of a maximum length segment of a preemptable packet from the second queue after the transmit controller suspends transmission from the second queue.

Embodiment 10: The network device of embodiment 9, wherein the one or more processing stages configured to process the packet after the timestamp is inserted into the packet and before the packet is enqueued in the first queue include an encryption stage configured to encrypt the packet including encryption the timestamp inserted in the packet.

Embodiment 11: A method for transmitting packets, comprising: receiving a packet at a transmit controller of the network device, the packet directed to a first queue configured to queue express packets to be transmitted via a network interface of the network device, the express packets including one or more types of packets that require transmission at specific transmit times; determining, by the transmit controller, whether the packet directed to the first queue is a type of packet that requires transmission at a specific transmit time; and in response to determining that the packet directed to the first queue is a type of packet that requires transmission at a specific transmit time, i) suspending, by the transmit controller, an ongoing transmission of a preemptable packet from a second queue that would prevent transmission of the packet from the first queue at the specific transmit time via the network interface, the second queue configured to queue preemptable packets that are to be transmitted via the network interface of the network device, the preemptable packets not having a requirement to be transmitted at specific transmit times and ii) causing, by the transmit controller, the packet in the first queue to be transmitted at the specific transmit time via the network interface.

Embodiment 12: The method of embodiment 11, further comprising: temporarily holding, by the network device, dispatch of the packet to the first queue if the first queue is not empty, while holding dispatch of the packet, determining, by the network device, that the first queue has become empty, and in response to determining that the first queue has become empty, dispatching, by the network device, the packet to be placed directly at a head of the first queue to ensure that transmission of the packet from the first queue at the specific transmit time will not be blocked by transmission of any other packet from the first queue at the specific transmit time.

Embodiment 13: The method of embodiments 11 or 12, further comprising: prior to determining, by the transmit controller, whether the packet is a type of packet that requires transmission at a specific transmit time from the network device, determining, by the transmit controller, that the first queue has become empty, and in response to determining that the first queue has become empty, proactively suspending, by the transmit controller, transmission from the first queue to ensure that if the packet directed to the first queue is a type of packet that requires transmission at a specific transmit time, the packet will not be prematurely transmitted from the network interface before the specific transmit time.

Embodiment 14: The method of any of embodiments 11-13, further comprising, in response to determining, by the transmit controller, that the packet directed to the first queue is a type of packet that requires transmission at a specific transmit time, i) holding, by the transmit controller, transmission of the packet from the first queue until the specific transmit time and ii) releasing, by the transmit controller, transmission of the packet from the first queue at the specific transmit time.

Embodiment 15: The method of any of embodiments 11-14, further comprising: at the specific transmit time, releasing, by the transmit controller, transmission of preemptable packets from the second queue to enable resumption of transmission of packets from the second queue after transmission of the packet from the first queue at the specific transmit time.

Embodiment 16: The method of embodiment 13, further comprising: in response to determining, by the transmit controller, that the packet directed to the first queue is not type of packet that requires transmission at a specific transmit time, releasing, by the transit controller, transmission of the packet from the first queue without waiting until any specific transmit time.

Embodiment 17: The method of any of embodiments 11-16, wherein determining that the packet is a type of packet that requires transmission at a specific transmit time comprises determining that the packet is a timestamped packet that requires transmission at a specific transmit time corresponding to the timestamp inserted in the packet.

Embodiment 18: The method of embodiment 17, further comprising: inserting, by the network device, a timestamp into the packet, the timestamp corresponding to a specific transmit time at which the packet is to be transmitted via the network interface of the network device, the specific transmit time being offset from a current time at which the timestamp is inserted into the packet by a maximum amount of delay that can be experienced by the packet after the timestamp is inserted by the network device into the packet.

Embodiment 19: The method of embodiment 18, further comprising: determining, by the network device, the specific time at which the packet is to be transmitted from the network device by adding an offset to the current time, the offset accounting for i) a maximum latency that can be introduced by one or more processing stages configured to process the packet after the timestamp is inserted in the packet and before the packet is enqueued in the first queue and ii) an amount of time required for transmission of a maximum length segment of a preemptable packet from the second queue after suspension of transmission from the second queue is asserted by the transmit controller.

Embodiment 20: The method of embodiment 19, further comprising processing the packet with the one or more processing stages after the timestamp is inserted in the packet, the processing including encrypting the packet including the timestamp inserted in the packet.

Although FIGS. 1-3 were described with reference to circuitry and/or circuits configured to perform various functions, in various other embodiments, one of, or any suitable combination of two or more of, the functions are performed by a processor (e.g., an embedded processor) executing machine readable instructions stored in a memory device such as a RAM, a read only memory (ROM), a Flash memory, etc. Accordingly, at least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any suitable computer readable memory such as RAM, a ROM, a flash memory, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), a system on a chip (SoC) device, etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A network device, comprising:
a first queue configured to queue express packets to be transmitted via a network interface of the network device, the express packets including one or more types of packets that require transmission at specific transmit times;
a second queue configured to queue preemptable packets that are to be transmitted via the network interface of the network device, the preemptable packets not having a requirement to be transmitted at specific transmit times; and
a transmit controller configured to:
receive a packet directed to the first queue,
determine whether the packet directed to the first queue is a type of packet that requires transmission at a specific transmit time, and
in response to determining that the packet directed to the first queue is a type of packet that requires transmission at a specific transmit time, i) suspend an ongoing transmission of a preemptable packet from the second queue that would prevent transmission of the packet from the first queue at the specific transmit time via the network interface and ii) cause the packet in the first queue to be transmitted at the specific transmit time via the network interface.

2. The network device of claim 1, further comprising a packet dispatch controller configured to, in connection with transmission of a packet that requires transmission at a specific transmit time,
temporarily hold dispatch of the packet if the first queue is not empty,
while holding dispatch of the packet, determine that the first queue has become empty, and
in response to determining that the first queue has become empty, dispatch the packet to be placed directly at a head of the first queue to ensure that transmission of the packet from the first queue at the specific transmit time will not be blocked by transmission of any other packet from the first queue at the specific transmit time.

3. The network device of claim 1, wherein the transmit controller is configured to, prior to determining whether the packet directed to the first queue is a type of packet that requires transmission at a specific transmit time,
determine that the first queue has become empty, and
in response to determining that the first queue has become empty, proactively suspend transmission from the first queue to ensure that if the packet directed to the first queue is a type of packet that requires transmission at a specific transmit time, the packet will not be prematurely transmitted from the network interface before the specific transmit time.

4. The network device of claim 3, wherein the transmit controller is configured to, in response to determining that the packet directed to the first queue is a type of packet that requires transmission at a specific transmit time, i) hold transmission of the packet from the first queue until the specific transmit time and ii) release transmission of the packet from the first queue at the specific transmit time.

5. The network device of claim 4, wherein the transmit controller is further configured to, at the specific transmit time, release transmission of preemptable packets from the second queue to enable resumption of transmission of packets from the second queue after transmission of the packet from the first queue at the specific transmit time.

6. The network device of claim 3, wherein the transmit controller is configured to, in response to determining that the packet directed to the first queue is not a type of packet that requires transmission at a specific transmit time, release transmission of the packet from the first queue without waiting until any specific transmit time.

7. The network device of claim 1, wherein the transmit controller is configured to determine that the packet is a type of packet that requires transmission at a specific transmit time at least by determining that the packet is a timestamped packet that requires transmission at a specific transmit time corresponding to the timestamp inserted in the packet.

8. The network device of claim 7, further comprising timestamping circuitry configured to insert a timestamp into the packet, the timestamp corresponding to a specific transmit time at which the packet is to be transmitted via the network interface of the network device, the specific transmit time being offset from a current time at which the timestamp is inserted into the packet by a maximum amount of delay that can be experienced by the packet after the timestamping circuitry inserts the timestamp into the packet.

9. The network device of claim 8, wherein the timestamping circuitry is configured to determine the specific time at which the packet is to be transmitted from the network device by adding an offset to the current time, the offset accounting for i) a maximum latency that can be introduced by one or more processing stages configured to process the packet after the timestamp is inserted into the packet and before the packet is enqueued in the first queue and ii) an amount of time required for transmission of a maximum length segment of a preemptable packet from the second queue after the transmit controller suspends transmission from the second queue.

10. The network device of claim 9, wherein the one or more processing stages configured to process the packet after the timestamp is inserted into the packet and before the packet is enqueued in the first queue include an encryption stage configured to encrypt the packet including encryption the timestamp inserted in the packet.

11. A method for transmitting packets, the method comprising:
receiving a packet at a transmit controller of the network device, the packet directed to a first queue configured to queue express packets to be transmitted via a network interface of the network device, the express packets including one or more types of packets that require transmission at specific transmit times;
determining, by the transmit controller, whether the packet directed to the first queue is a type of packet that requires transmission at a specific transmit time; and
in response to determining that the packet directed to the first queue is a type of packet that requires transmission at a specific transmit time, i) suspending, by the transmit controller, an ongoing transmission of a preemptable packet from a second queue that would prevent transmission of the packet from the first queue at the specific transmit time via the network interface, the second queue configured to queue preemptable packets that are to be transmitted via the network interface of the network device, the preemptable packets not having a requirement to be transmitted at specific transmit times and ii) causing, by the transmit controller, the packet in the first queue to be transmitted at the specific transmit time via the network interface.

12. The method of claim 11, further comprising:
temporarily holding, by the network device, dispatch of the packet to the first queue if the first queue is not empty,
while holding dispatch of the packet, determining, by the network device, that the first queue has become empty, and
in response to determining that the first queue has become empty, dispatching, by the network device, the packet to be placed directly at a head of the first queue to ensure that transmission of the packet from the first queue at the specific transmit time will not be blocked by transmission of any other packet from the first queue at the specific transmit time.

13. The method of claim 11, further comprising, prior to determining, by the transmit controller, whether the packet is a type of packet that requires transmission at a specific transmit time from the network device,
determining, by the transmit controller, that the first queue has become empty, and
in response to determining that the first queue has become empty, proactively suspending, by the transmit controller, transmission from the first queue to ensure that if the packet directed to the first queue is a type of packet that requires transmission at a specific transmit time, the packet will not be prematurely transmitted from the network interface before the specific transmit time.

14. The method of claim 13, further comprising, in response to determining, by the transmit controller, that the packet directed to the first queue is a type of packet that requires transmission at a specific transmit time, i) holding, by the transmit controller, transmission of the packet from the first queue until the specific transmit time and ii) releasing, by the transmit controller, transmission of the packet from the first queue at the specific transmit time.

15. The method of claim 14, further comprising, at the specific transmit time, releasing, by the transmit controller, transmission of preemptable packets from the second queue to enable resumption of transmission of packets from the second queue after transmission of the packet from the first queue at the specific transmit time.

16. The method of claim 13, further comprising, in response to determining, by the transmit controller, that the packet directed to the first queue is not type of packet that requires transmission at a specific transmit time, releasing, by the transit controller, transmission of the packet from the first queue without waiting until any specific transmit time.

17. The method of claim 11, wherein determining that the packet is a type of packet that requires transmission at a specific transmit time comprises determining that the packet is a timestamped packet that requires transmission at a specific transmit time corresponding to the timestamp inserted in the packet.

18. The method of claim 17, further comprising inserting, by the network device, a timestamp into the packet, the timestamp corresponding to a specific transmit time at which the packet is to be transmitted via the network interface of the network device, the specific transmit time being offset from a current time at which the timestamp is inserted into the packet by a maximum amount of delay that can be experienced by the packet after the timestamp is inserted by the network device into the packet.

19. The method of claim 18, further comprising determining, by the network device, the specific time at which the packet is to be transmitted from the network device by adding an offset to the current time, the offset accounting for i) a maximum latency that can be introduced by one or more processing stages configured to process the packet after the timestamp is inserted in the packet and before the packet is enqueued in the first queue and ii) an amount of time required for transmission of a maximum length segment of a preemptable packet from the second queue after suspension of transmission from the second queue is asserted by the transmit controller.

20. The method of claim 19, further comprising processing the packet with the one or more processing stages after the timestamp is inserted in the packet, the processing including encrypting the packet including the timestamp inserted in the packet.
